(19) United States
(12) Patent Application Publication
(10) Pub. No.: US 2011/0125292 A1
(43) Pub. Date: May 26, 2011

(54) STARTING DEVICE OF ELECTRONIC PRODUCT AND METHOD THEREOF

(75) Inventors: Ting-Lin Chang, Taoyuan County (TW); Ching-Feng Hsieh, Taipei City (TW)

(73) Assignee: ASKEY COMPUTER CORP., Taipei (TW)

(21) Appl. No.: 12/647,205

(22) Filed: Dec. 24, 2009

(30) Foreign Application Priority Data
Nov. 20, 2009 (TW) 098139543

(51) Int. Cl. G05B 11/01

(52) U.S. Cl. 700/12; 345/168

(57) ABSTRACT

In a starting device of an electronic product and a method thereof, the starting device includes a detecting unit for detecting a motion state of an external device and generating a detecting signal by a motion state, a keyboard unit for generating a key signal, a memory unit for storing parameters, and a processing unit. While the detecting signal and the key signal correspond to a starting signal, the processing unit starts to output the corresponding starting signal which can enable the electronic product to execute a function action according to the parameters. Thereby, a function action command can be executed by a combination of the detecting signal and the key signal, and it is capable of simplifying the operation procedure and improving the work efficiency.

### CROSS-REFERENCE TO RELATED APPLICATIONS

This non-provisional application claims priority under 35 U.S.C. §119(a) on Patent Application No(s). 098139543 filed in Taiwan, R.O.C. on 20 Nov., 2009, the entire contents of which are hereby incorporated by reference.

### FIELD OF THE INVENTION

The present invention relates to a starting device and a starting method, in particular to a starting device and a starting method of an electronic product.

### BACKGROUND OF THE INVENTION

As barcode is used extensively in many areas including a commercial information barcode, the convenience of reading barcode information by a barcode reader determines an operator's work efficiency, and a convenient operation can expedite an operating procedure. When data are read in accordance with a prior art, a user generally starts a scanning action command at a control end of a barcode scanner, and executes a scanning action by pressing a scan key installed on the barcode scanner. However, the frequency of pressing the scan key is increased substantially to meet the requirement of a large number of scanning or a continuous scanning, and thus the scan key may be damaged easily. Furthermore, a continuous scanning requires resetting the scanning action command repeatedly in order to let the barcode scanner execute the continuous scanning action. In the aforementioned action, the user has to repeat operations between the control end and the barcode scanner, and such arrangement not just lowers the efficiency of the operation only, but also consumes additional electric power for starting the operation at the control end.

In another prior art as disclosed in R.O.C. Pat. Application No. TW200724921, a device capable of determining whether or not a machine is situated at a motion state and triggering a specific function is disclosed, and the device includes a movable sensor for sensing a motion parameter of a portable electronic product, and transmitting the motion parameter to a microprocessor. The microprocessor includes a determination process for determining whether or not the motion parameter is a meaningful motion, and bases on a determination result to instruct a device controller to start a corresponding device function. However, the actual operation of the machine will produce vibrations, and it requires a stricter threshold for determining a result accurately to identify a meaningful motion, or else users have to adopt a larger vibrating action to achieve the triggering effect, which will make the application inconvenient.

Furthermore, the execution of a specific function by a conventional barcode scanner requires users to select the commands on a menu step by step to execute the specific function. Obviously, the conventional barcode scanner is complicated and inconvenient.

### SUMMARY OF THE INVENTION

Therefore, it is a primary objective of the present invention to provide a starting device and a starting method of an electronic product to overcome the shortcomings of the prior art that requires a complicated operation in a menu to execute a specific function action.

To achieve the foregoing and other objectives, the present invention discloses a starting device of an electronic product, and the starting device comprises: a detecting unit, for detecting a motion state of an external device, and generating a detecting signal according to the motion state; a keyboard unit, for generating a key signal; a memory unit, for storing a predetermined parameter of the detecting signal, a predetermined parameter of the key signal, and a plurality of starting signals corresponding to a combination of the predetermined parameters of the detecting signal and the key signal; and a processing unit, electrically coupled to the detecting unit, the keyboard unit and the memory unit, for receiving the detecting signal and the key signal, and outputting a corresponding starting signal according to the predetermined parameters of the detecting signal and the key signal to drive the electronic product to execute a corresponding function action.

In a preferred embodiment of the present invention, the detecting unit comprises: a detector, for detecting the motion state, and generating the detecting signal; and an analog/digital converter, electrically coupled to the detector and the processing unit, for performing an analog/digital conversion of the detecting signal, wherein the detector is an acceleration detector, a gyroscope, or a combination of the acceleration detector and the gyroscope, and the electronic product is a handheld data collection product.

To achieve the foregoing and other objectives, the present invention provides a starting method of an electronic product, and the starting method comprises the steps of: (a) defining and pre-storing a predetermined parameter of a detecting signal and a predetermined parameter of a key signal, and a starting signal corresponding to a combination of the predetermined parameters of the detecting signal and the key signal; (b) detecting a motion state of an external device, and generating a detecting signal according to the motion state; (c) comparing the detecting signal with an inputted key signal, and outputting a corresponding starting signal if the detecting signal and the key signal correspond to the combination of predetermined parameters of the pre-stored detecting signal and key signal; and (d) executing a corresponding function action according to the starting signal, wherein the step (c) further comprises the step of outputting a corresponding the starting signal if the predetermined parameter of the detecting signal is a motion state change, and the detecting signal matches the motion state change and the key signal corresponds to the predetermined parameter of the key signal. In addition, the predetermined parameters of the detecting signal can be a plurality of motion state action values, wherein if the detecting signal matches one of the motion state action values and the key signal corresponds to the predetermined parameter of the key signal, the corresponding starting signal will be outputted.

The motion state of the electronic product is used together with the key signal to achieve the effect of automatically enabling the electronic product to execute the specific function action, and the press key is further used together for preventing errors of the electronic product when the electronic product falls or in any other situation of changing the motion state. Therefore, the present invention can use an appropriate motion state of the electronic product with the press key to drive a device to execute a specific function action automatically, and provide a consistent operation to achieve the effects of simplifying the key operation procedure and improving the work efficiency.

To make it easier for the examiner to understand the objects, characteristics and effects of this invention, we use a preferred embodiment together with the attached drawings for the detailed description of the invention.

### BRIEF DESCRIPTION OF THE DRAWINGS

FIG. 1 is a schematic view of a motion track of an electronic product during its operation;

FIG. 2 is a functional block diagram of a starting device in accordance with a first preferred embodiment of the present invention;

FIG. 3 is a functional block diagram of a starting device in accordance with a second preferred embodiment of the present invention;

FIG. 4 is a schematic view of a motion state of a starting device in accordance with a first preferred embodiment of the present invention;

FIG. 5 is a functional block diagram of a starting device in accordance with a third preferred embodiment of the present invention; and

FIG. 6 is a flow chart of a starting method of an electronic product in accordance with the present invention.

### DESCRIPTION OF THE PREFERRED EMBODIMENTS

Other features and advantages of the present invention will become apparent in the following detailed description of the preferred embodiments with reference to the accompanying drawings.

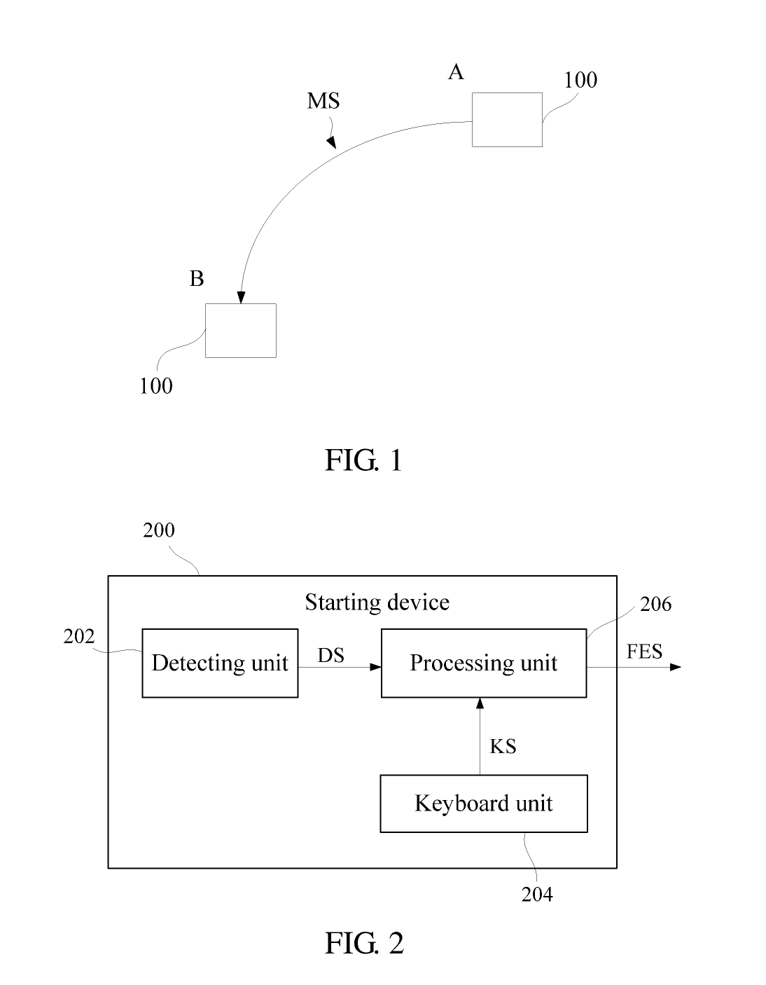

With reference to FIG. 1 for a schematic view of a motion track of an electronic product during its operation, the electronic product 100 is moved from Point A to Point B to constitute a motion state MS. As to the electronic product 100, the motion state MS varies with a user's action, and the electronic product 100 can be moved in any direction with a physical change, such as a change of speed, acceleration or gravitational force, etc. It is noteworthy to point out that the electronic product 100 may have a change of speed, acceleration or gravitational force according to a combination of different directions and physical quantity to match the produced motion state MS. Therefore, the electronic product 100 can detect the change of speed, acceleration or gravitational force by a starting device to enable the electronic product 100 to execute a corresponding function action, so as to simplify the operation of a complicated menu.

For example, a handheld data collection product will be moved continuously for capturing data, and users can press a specific key at a desired fixed point of capturing data to enable the handheld data collection product to execute the data collecting function action. Now, the handheld data collection product will have a change of a physical quantity such as speed, acceleration or gravitational force, and the change is used as a basis for starting the data collecting function action automatically, such that the users can reduce the number of pressing the key significantly, and the specific physical quantity can be set to allow user to move the handheld data collection product directly to enable the data collector to execute a corresponding function action.

With reference to FIG. 2 for a functional block diagram of a starting device in accordance with a first preferred embodiment of the present invention, the starting device 200 comprises a detecting unit 202, a keyboard unit 204 and a processing unit 206. The detecting unit 202 is provided for detecting a motion state MS of the electronic product 100, and generating a detecting signal DS according to the motion state MS. The keyboard unit 204 can be pressed by a user to output keyboard unit a key signal KS according to the user's operation. For example, the detecting unit 202 is an acceleration detector, a gyroscope, or a combination of the two (which is generally called G-sensor). In this preferred embodiment, the processing unit 206 is electrically coupled to the detecting unit 202 and the keyboard unit 204 for receiving a detecting signal DS and a key signal KS, and selectively outputting a corresponding starting signal FES, wherein the processing unit 204 determines whether or not the detecting signal DS and the key signal KS match default conditions according to a predetermined parameter of the detecting signal and a predetermined parameter of the key signal. If the detecting signal DS and the key signal KS match the predetermined parameters, a corresponding starting signal will be generated, and outputted by the processing unit 206 to drive the electronic product 100 to execute the corresponding function action. It is noteworthy to point out that the keyboard unit 204 and the processing unit 206 in the starting device 200 can be components originally installed in the electronic product 100, and the present invention adopts the detecting unit 202 and the original electronic product that includes the keyboard unit 204 and the processing unit 206 to form the starting device 200. In addition, the keyboard unit 204 can include the original electronic product having a press key and an additional installed press key.

In this preferred embodiment, the predetermined parameters of the detecting signal and the key signal can be stored in a built-in memory unit of the processing unit 206. For example, the electronic product 100 can be a handheld data collection product, and the processing unit 206 installs a set of predetermined parameters of the detecting signal and key signal and the corresponding scanning signal. If the detecting signal DS and the key signal KS match stored default conditions, the starting device 200 will enable the handheld data collection product to execute a scanning action for collecting data.

In a preferred embodiment of the handheld data collection product, the handheld data collection product is moved during the process of collecting data by users, and stopped at a position for scanning data when it is moved to a desired scanning target, and thus the body of the handheld data collection product comes with several different motion states. As to the scanning action such as a change of acceleration, an acceleration is produced when a user scans a target object by moving the handheld data collection product, and the value of acceleration will be reduced or eliminated when the handheld data collection product is moved to the target object. Now, there is a change of acceleration. Therefore, the predetermined parameter of the detecting signal can be a change of motion state. In other words, if the acceleration exceeds a predetermined threshold, a first condition will be satisfied. If the acceleration is reduced to zero, then a second condition will be satisfied. If both first and second conditions are satisfied, there will be a change of motion state. If the predetermined parameter of the key signal together with the key signal KS match the predetermined parameters of the key signal, such as the predetermined parameter of the key signal is set to a certain key signal, then the detecting signal DS and the key signal KS will match the default conditions. Now, the starting device 200 will enable the handheld data collection product to execute the scanning action. Since it is necessary for the handheld data collection product to move in order to take the scanning action, therefore the present invention includes at least one press key to give command to the handheld data collection product to execute the scanning action automatically, and the predetermined parameter of the key signal has a better effect of preventing the scanning action from being triggered accidentally than the predetermined parameter of the detecting signal.

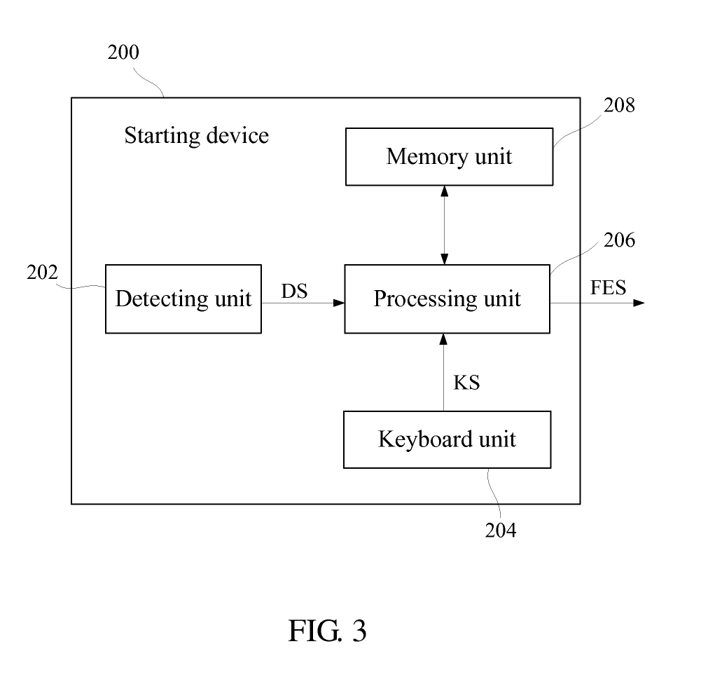

With reference to FIG. 3 for a functional block diagram of a starting device in accordance with a second preferred embodiment of the present invention, the starting device 200 further comprises a memory unit 208 as shown in FIG. 3, and the memory unit 208 is electrically coupled to the processing unit 206 (wherein the memory unit 208 is built in the processing unit 206 as described in the aforementioned preferred embodiment) and provided for storing the predetermined parameters of the detecting signal, the key signal and the detecting signal predetermined parameters, and a corresponding starting signal composed of the predetermined parameter of the key signal. The handheld data collection product of this embodiment can enable the handheld data collection product to perform a scanning action only, and the structure of the present invention can store a plurality of predetermined parameters of the detecting signal, a plurality of predetermined parameters of the key signal and a plurality of starting signals. One of the starting signals will correspond to a set of parameters, which includes a predetermined parameter of the detecting signal and a predetermined parameter of the key signal. In other words, the combination of a set of parameters corresponds to a starting signal. With the combination of the parameters, different starting signals can be defined, such that the electronic product can execute different function actions accordingly. However, the persons ordinarily skilled in the art can understand that the predetermined parameter of a key signal together with the predetermined parameter of a different detecting signal can correspond a plurality of starting signals. On the other hand, the predetermined parameter of a detecting signal together with the predetermined parameter of a different key signal can correspond to a plurality of starting signals. For example, the function actions include: enabling and disabling a certain function. Traditionally, it is necessary for users to enter into a menu of the electronic product to select and execute different functions, and the present invention can omit this step to simplify the operation procedure, and users can execute a desired function action according to the user's setting and define the predetermined parameters of the detecting signal and the key signal corresponding to the function action.

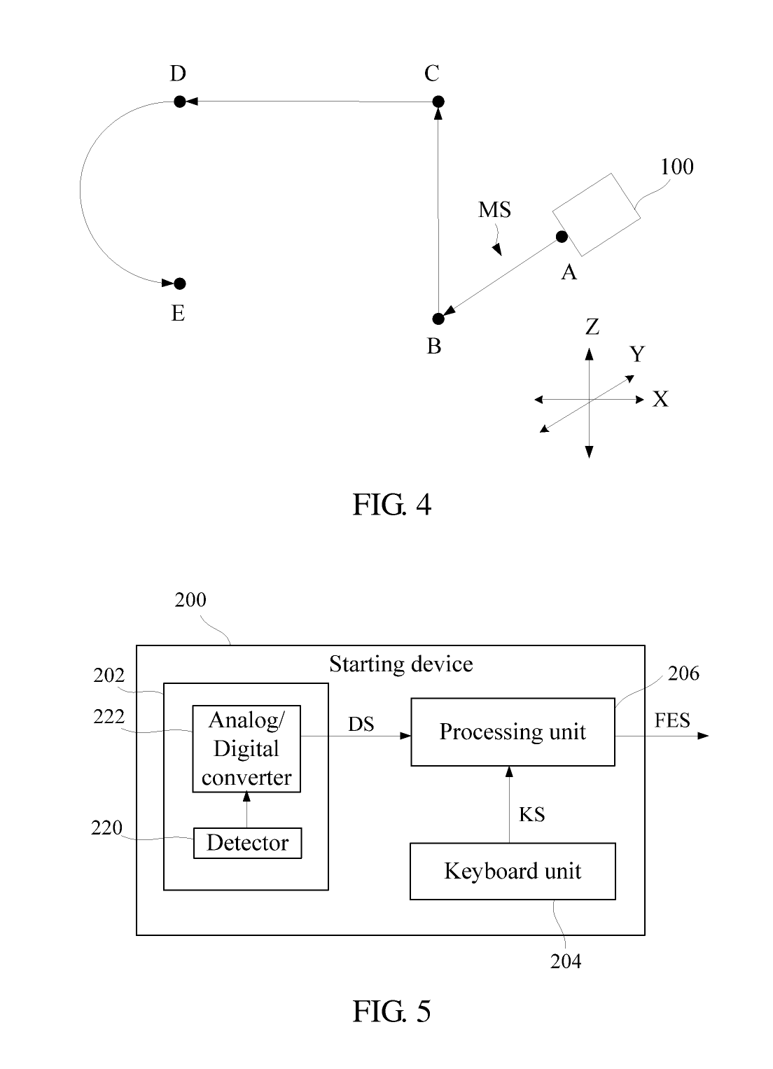

With reference to FIG. 4 for a schematic view of a motion state of a starting device in accordance with a first preferred embodiment of the present invention, the electronic product 100 is a data scanning device for performing a scanning action, and the motion state MS of the electronic product 100 is defined as a movement from Point A to Point B in the y-axis direction. Now, the scanning action is not enabled when the electronic product 100 is situated at Point A. Assumed that the acceleration exceeds a predetermined threshold and satisfies a first condition if the motion state of the electronic product 100 continues moving from Point A to Point B, and then stops moving if the electronic product is moved to Point B, such that the acceleration is reduced to zero to meet a second condition. If a user presses the preset press keys simultaneously now, the electronic product 100 will be enabled to execute a corresponding function action, which is a scanning action here. If the electronic product 100 continues to move towards the z-axis direction, then the scanning action will not be enabled when the electronic product 100 is situated at Point B, and the first condition will be satisfied if the motion state of the electronic product 100 continues moving from Point B to Point C, and the second condition will be satisfied if the electronic product 100 is stopped at Point C. If the user presses the preset press keys simultaneously now, then the electronic product 100 will be enabled again to execute the corresponding scanning action. If the electronic product 100 further moves towards the x-axis direction, then the scanning action will not be started 100 when the electronic product is situated at Point C. If the electronic product 100 continues moving between Points C and Point D and stops moving at Point D, and the preset press keys are pressed simultaneously, then the electronic product 100 will be enabled again to execute the corresponding scanning action. If the motion state of the electronic product 100 is an angular motion, such as a circumferential motion locus, then the scanning action will not be started when the electronic product 100 is situated at Point D. If the electronic product 100 continues moving between Points D and E and stops moving at Point E, and the preset press keys are pressed simultaneously, then the electronic product 100 will be enabled to execute a corresponding scanning action. It is noteworthy to point out that the predetermined threshold can be the most appropriate threshold set according to a user's preference. In this embodiment, a preset press key is provided, so that users can press the preset press key directly, such that the change of the motion state of the electronic product 100 can enable the scanning action according to the motion state, and users can save the trouble of pressing the press key each time for scanning data, and thus making the scanning action very smooth. In addition, the preset press key can be designed in such a way that the press key will be fixed after pressing it once, so that users need not to keep pressing the press key, and the structure of such press key is a prior art and will not be described here.

With reference to FIG. 5 for a functional block diagram of a starting device in accordance with a third preferred embodiment of the present invention, the detecting unit 202 comprises a detector 220 and an analog/digital converter 222, wherein the detector 220 is provided for detecting a motion state of an external device and generating a detecting signal DS, and the external device refers to an external device of the detecting unit 202 which is also the electronic product 100; and the analog/digital converter 222 is installed between the detector 220 and the processing unit 206 for converting an analog detecting signal into a digital detecting signal DS and outputting the digital detecting signal DS. The detector 220 can be an acceleration detector, a gyroscope, or a combination of the two, and the gyroscope is provided for detecting an inclined post, such that the predetermined parameters of detecting signal may have more changes to produce more combinations of the predetermined parameters of the key signal.

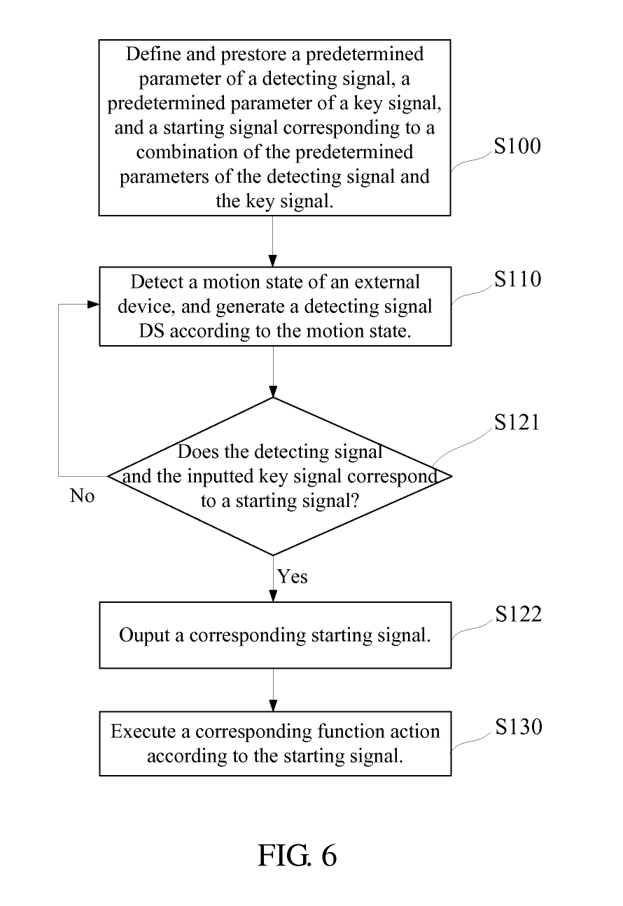

With reference to FIG. 6 for a flow chart of a starting method of an electronic product in accordance with the present invention, the starting method comprises the following steps:

Step S100: Defining and pre-storing a predetermined parameter of a detecting signal, a predetermined parameter of a key signal, and a starting signal corresponding to a combination of the predetermined parameters of the detecting signal and the key signal; Step S110: Detecting a motion state of an external device, and generating a detecting signal DS according to the motion state; Step S121: Comparing and checking whether or not the detecting signal DS and the inputted key signal KS correspond to a starting signal; in other words, if the detecting signal and the key signal correspond to the combination of pre-stored predetermined parameters of the detecting signal and the key signal, then the procedure will enter into Step S122 to output a corresponding starting signal, or else the procedure will return to Step S110; Step S130: Executing a corresponding function action according to the starting signal. As described above, the function action can be a scanning action, and the electronic product is a handheld data collection product. In addition, Steps S121 and S122 indicate that the corresponding starting signal is outputted when the detecting signal DS and the key signal KS correspond to a starting signal.

In the Step S121 of a preferred embodiment, if the detecting signal DS and the key signal KS match corresponding predetermined parameters of the detecting signal and the key, then the corresponding starting signal will be outputted, wherein the predetermined parameter of the detecting signal is a change of motion state, and if the detecting signal DS matches the change of the motion state and the key signal KS correspond to the predetermined parameters of the key signal, then the corresponding starting signal will be outputted.

In the Step S121 of another preferred embodiment, the predetermined parameters of the detecting signal are a plurality of motion state action values, such that if the detecting signal DS matches one of the motion state action values and the key signal KS corresponds to the predetermined parameter of the key signal, then the corresponding starting signal will be outputted. The motion state action values refer to different moving statuses of the electronic product, such as an action value is set for a left swing or a right swing, or an action value is set for two left swings or two right swing, or an action is set for a change of acceleration.

In summation of the description above, the present invention uses a motion state of an external device together with a key signal to achieve the effect of automatically enabling an electronic product to execute a specific function action, and a press key is used together for preventing errors of the electronic product if the electronic product falls or has other situations when its motion state is changed. Therefore, the present invention can use an appropriate motion state of the electronic product together with the press key to drive the device to execute a specific function action automatically and provide a consistent operation.

In summation of the description above, the present invention provides a feasible design and complies with patent application requirements, and thus is duly filed for patent application.

While the invention has been described by means of specific embodiments, numerous modifications and changes could be made thereto by those skilled in the art without departing from the scope and spirit of the invention set forth in the claims.

What is claimed is:

1. A starting device of an electronic product, applied for enabling the electronic product to execute a corresponding function action, and comprising:
a detecting unit, for detecting a motion state of an external device, and generating a detecting signal according to the motion state;
a keyboard unit, for generating a key signal;
a memory unit, for storing a predetermined parameter of the detecting signal, a predetermined parameter of the key signal, and a plurality of starting signals corresponding to a combination of the predetermined parameters of the detecting signal and the key signal; and
a processing unit, electrically coupled to the detecting unit, the keyboard unit and the memory unit, for receiving the detecting signal and the key signal, and outputting a corresponding starting signal according to the predetermined parameters of the detecting signal and the key signal to drive the electronic product to execute a corresponding function action.

2. The starting device of claim 1, wherein the detecting unit comprises:
a detector, for detecting the motion state, and generating the detecting signal; and
an analog/digital converter, electrically coupled to the detector and the processing unit, for performing an analog/digital conversion of the detecting signal.

3. The starting device of claim 2, wherein the detector is one selected from the collection of an acceleration detector, a gyroscope, and a combination of the acceleration detector and the gyroscope.

4. The starting device of claim 1, wherein the electronic product is a handheld data collection product.

5. A starting method of an electronic product, comprising the steps of:
(a) defining and pre-storing a predetermined parameter of a detecting signal and a predetermined parameter of a key signal, and a starting signal corresponding to a combination of the predetermined parameters of the detecting signal and the key signal;
(b) detecting a motion state of an external device, and generating a detecting signal according to the motion state;
(c) comparing the detecting signal with an inputted key signal, and outputting a corresponding starting signal if the detecting signal and the key signal correspond to the combination of predetermined parameters of the pre-stored detecting signal and key signal; and
(d) executing a corresponding function action according to the starting signal.

6. The starting method of claim 5, wherein the function action is a scanning action.

7. The starting method of claim 6, wherein the predetermined parameters of the detecting signal in the step (c) are a plurality of motion state action values, and the corresponding starting signal will be outputted if the detecting signal matches one of the motion state action values and the key signal corresponds to the predetermined parameter of the key signal.

8. The starting method of claim 6, wherein the predetermined parameters of the detecting signal in the step (c), are motion state changes, and the corresponding starting signal will be outputted if the detecting signal matches the motion state change and the key signal corresponds to the predetermined parameter of the key signal.
